(19) United States
(12) Patent Application Publication
(10) Pub. No.: US 2026/0024968 A1
(43) Pub. Date: Jan. 22, 2026

(54) UNIVERSAL CABLE INSTALLATION AND MANAGEMENT SYSTEM

(71) Applicants: Rashid Zralov, Coral Springs, FL (US); Dzmitry Slesar, Philadelphia, PA (US)

(72) Inventors: Rashid Zralov, Coral Springs, FL (US); Dzmitry Slesar, Philadelphia, PA (US)

(21) Appl. No.: 19/272,927

(22) Filed: Jul. 17, 2025

Related U.S. Application Data
(60) Provisional application No. 63/672,690, filed on Jul. 17, 2024.

(51) Int. Cl. H02G 3/04

(52) U.S. Cl. CPC H02G 3/0456

(57) ABSTRACT

A universal cable installation and management system may comprise a plurality of drakkar devices and a plurality of rook devices. The drakkar devices may include a drakkar mid dress device configured to organize cables into specific patterns and secure the cables with attachment strips. A drakkar base pull device may be configured to be installed at predetermined pathway points through technical mounting holes. A drakkar mid pull device may be configured to stack on the drakkar base pull device for accommodating multiple cable layers. A drakkar cap pull device may be configured to terminate device stacks. The rook devices may include a rook pull base device configured to form temporary combs for cable pattern maintenance during dressing operations. A rook pull mid device may be configured to stack on the rook pull base device for multiple cable layers. A rook pull cap device may be configured to terminate temporary comb assemblies. All devices may include snap-on connectors enabling rapid assembly and disassembly. The system may be configured to maintain cable organization patterns throughout an entire installation process.

### CROSS-REFERENCE TO RELATED APPLICATIONS

This application claims priority to U.S. Provisional Patent Application No. 63/672,690, filed Jul. 17, 2024, the entire contents of which are incorporated herein by reference.

### TECHNICAL FIELD

The present disclosure relates generally to cable management systems, and more particularly to a universal cable installation and management system for maintaining cable organization patterns during installation, dressing, and maintenance operations in data centers and similar facilities.

### BACKGROUND

The following description of related art is provided to assist the reader in understanding the advantages of the present disclosure. The following discussion is not an admission that any of the information provided herein is prior art or relevant to the presently claimed subject matter, or that any publication specifically or implicitly referenced is prior art.

Cable installation in data centers and similar facilities traditionally involves bundling cables without maintaining specific patterns. This conventional approach requires sequential connection processes where one end of the cable bundle is connected first, followed by pattern organization and dressing along the entire cable length, and then connection of the opposite end. After the initial connection, the bundle must be loosened to accommodate service loops and dressed again before additional cable layers can be installed.

This traditional methodology presents several limitations. The sequential connection requirement prevents simultaneous termination at both cable ends, significantly extending installation time. Multiple dressing operations are required throughout the installation process, increasing labor requirements and project duration. Complete bundle disassembly is necessary for individual cable maintenance or replacement, disrupting the entire cable organization system.

Existing cable management systems focus primarily on final cable support and organization rather than maintaining patterns throughout the entire installation process. These systems do not address the fundamental inefficiencies in cable laying methodology or provide solutions for pattern preservation during the critical installation phase.

The present disclosure addresses these limitations by providing a comprehensive system that maintains cable organization patterns from initial bundling through final installation, enabling simultaneous connections and reducing maintenance complexity.

### Brief Overview

The following presents a simplified overview of some aspects of the disclosed subject matter in order to provide a basic understanding. This overview is not an extensive survey of all aspects of the disclosed subject matter. It is intended neither to identify key or critical elements of the disclosed subject matter nor to delineate the scope of such aspects. Its sole purpose is to present some concepts of the disclosed subject matter in a simplified form as a prelude to the more detailed description that is presented later. The overview is not intended to limit the scope of the claimed subject matter.

A universal cable installation and management system may comprise multiple interconnected plastic devices designed to maintain cable organization patterns throughout an entire installation process. The system may include a first device series for cable laying and pulling operations and a second device series for cable dressing and permanent support.

The first device series may include a mid dress device for organizing cables into specific patterns and securing them with attachment strips. A base pull device may be installed at predetermined pathway points through technical mounting holes. A mid pull device may stack on base pull devices for accommodating multiple cable layers. A cap pull device may terminate device stacks when no additional cables are required.

The second device series may include a pull base device forming temporary combs for cable pattern maintenance during dressing operations. A pull mid device may stack on pull base devices for multiple cable layers. A pull cap device may terminate temporary comb assemblies. A dress base device may provide permanent support with tighter cable fit. A dress mid device may provide permanent stackable sections. A dress cap device may provide permanent termination caps.

All devices may feature snap-on connectors enabling rapid assembly and disassembly. The system may support modular configuration based on cable quantity and routing requirements. The system may enable simultaneous connections at both cable ends immediately following installation while maintaining organized patterns throughout the process.

The system may reduce installation time by approximately fifty percent compared to traditional methods. The system may enable individual cable identification and replacement without complete bundle disassembly. The system may reduce personnel requirements for large-scale cable installations while improving cable management quality.

It should be understood that the foregoing general description and the following detailed description are exemplary and explanatory only and are not restrictive of the aspects of the embodiments disclosed herein. The described embodiments may be implemented in numerous ways, including as a system, a process, an apparatus, or a series of program instructions on a computer readable medium. The described embodiments are not limited to any particular combination of hardware and software, and various modifications may be made without departing from the scope of the disclosure.

### BRIEF DESCRIPTION OF THE DRAWINGS

The drawings described herein are for illustration purposes only and are not intended to limit the scope of the present disclosure in any way. The drawings are not necessarily drawn to scale and may not show all features or details of the actual embodiments. Various modifications and variations may be made to the illustrated embodiments without departing from the spirit and scope of the disclosure.

FIG. 1 illustrates a technical drawing of a drakkar base device 10 showing isometric, front, and side views with dimensional annotations.

FIG. 2 illustrates a technical drawing of a drakkar mid pull device 20 showing perspective, front elevation, and side elevation views with dimensional annotations.

FIG. 3 illustrates a technical drawing of a drakkar cap device 30 showing isometric, top, front, and side views with dimensional annotations.

FIG. 4 illustrates an assembly diagram 400 showing the arrangement of drakkar cap parts, drakkar mid parts, and drakkar base parts in a grid configuration with an inset detail of the drakkar sprite assembly.

FIG. 5 illustrates a technical drawing of a rook device 50 showing multiple views including front, top, side, and isometric views with dimensional annotations.

FIG. 6 illustrates a technical drawing of a rook cap device 60 showing isometric, top, and side views with dimensional annotations.

FIG. 7 illustrates a rook system assembly diagram 700 showing the arrangement of rook cap parts, rook mid parts, and rook base parts with an assembly table.

The drawings are provided to illustrate various aspects of the disclosed embodiments and are not intended to be limiting. The reference numerals used in the drawings are consistent throughout the specification and claims. Additional drawings may be provided as needed to fully illustrate the various embodiments and their components.

### DETAILED DESCRIPTION

The following detailed description refers to the accompanying drawings. The same reference numbers in different drawings may identify the same or similar elements. The following detailed description does not limit the claims. Instead, the scope of the embodiments is defined by the appended claims and their equivalents.

Reference throughout this specification to “one embodiment,” “an embodiment,” “some embodiments,” or similar language means that a particular feature, structure, or characteristic described in connection with the embodiment is included in at least one embodiment of the present disclosure. Appearances of the phrases “in one embodiment,” “in an embodiment,” “in some embodiments,” and similar language throughout this specification may, but do not necessarily, all refer to the same embodiment.

The described features, structures, or characteristics of the embodiments may be combined in any suitable manner. In the following description, numerous specific details are provided to give a thorough understanding of embodiments. One skilled in the relevant art will recognize, however, that the various embodiments can be practiced without one or more of the specific details, or with other methods, components, materials, and so forth. In other instances, well-known structures, materials, or operations are not shown or described in detail to avoid obscuring aspects of the embodiments.

The universal cable installation and management system may comprise multiple interconnected devices designed to maintain cable organization patterns throughout an entire installation process from initial laying to final dressing and maintenance. The system may address fundamental inefficiencies in traditional cable installation methodologies by enabling pattern preservation during critical installation phases.

The system may operate within data center environments and similar facilities requiring organized installation of large numbers of cables. The system may integrate with existing cable pathway infrastructure while utilizing standard cable routes, turns, and termination points. The system may support conventional cable pulling equipment including drag lanes and pull ropes.

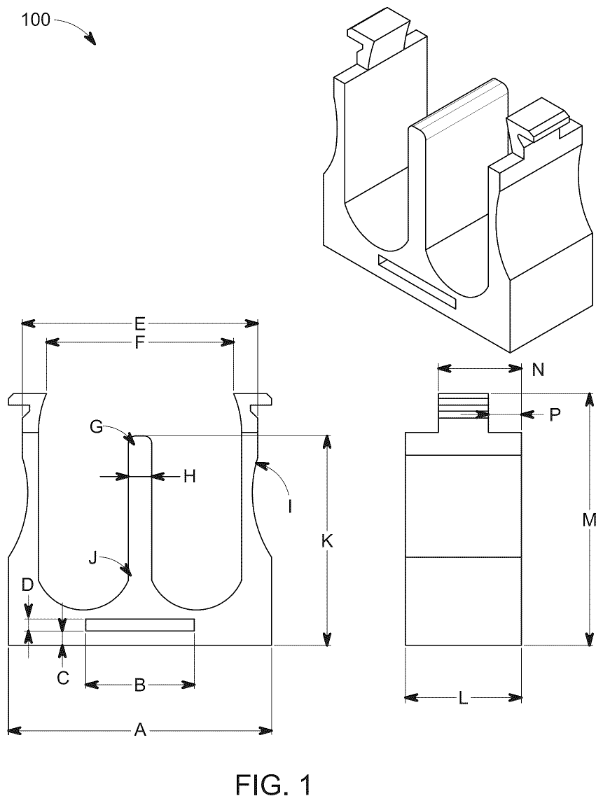

Referring to FIG. 1, a drakkar base device 10 may provide a foundation component for cable pathway installation. The device 10 may include a base portion with technical mounting holes for installation at predetermined pathway points. The device 10 may include vertical slots for cable routing and pattern maintenance. The device 10 may include snap-on connector interfaces for vertical stacking with additional components.

The drakkar base device 10 may be installed at the beginning of cable paths, at each turn, and at termination points. The device 10 may support cable pulling forces while maintaining organized cable patterns. The device 10 may accommodate multiple cable layers through stackable configurations.

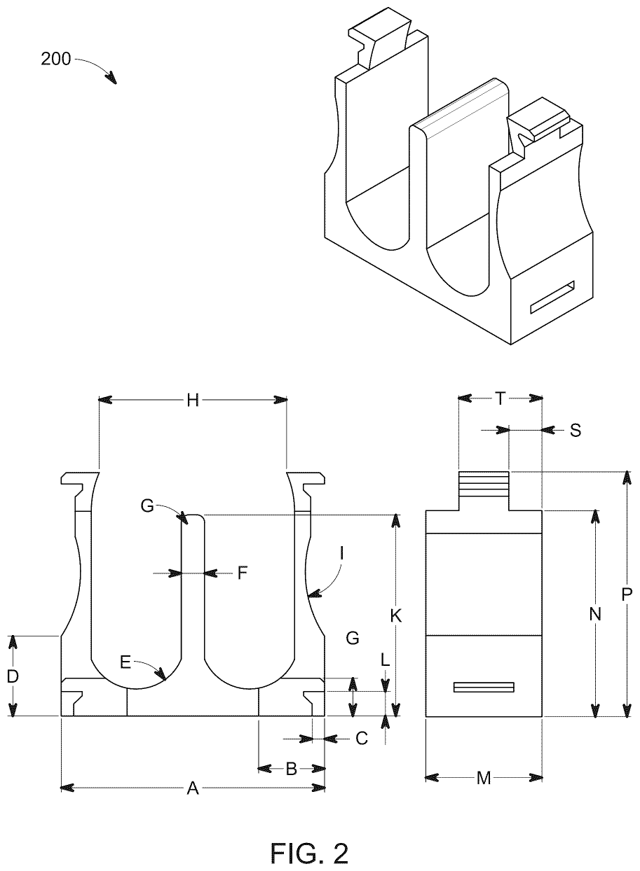

Referring to FIG. 2, a drakkar mid pull device 20 may provide intermediate stacking capability for multiple cable layers. The device 20 may include dual compartments for cable organization and routing. The device 20 may include snap-on connectors for attachment to base devices and cap devices. The device 20 may maintain cable patterns during stacking operations.

The drakkar mid pull device 20 may be installed on drakkar base devices when additional cable bundles are required above current installations. The device 20 may support vertical cable organization while preserving horizontal patterns. The device 20 may enable modular configuration based on cable quantity requirements.

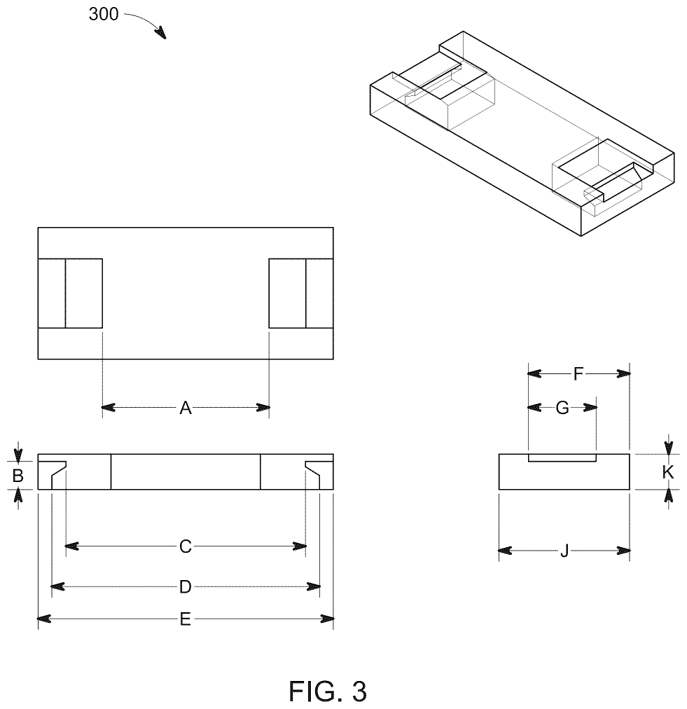

Referring to FIG. 3, a drakkar cap device 30 may provide termination capability for device stacks. The device 30 may include rectangular cutouts for final cable routing and pattern maintenance. The device 30 may include snap-on connectors for attachment to mid pull devices. The device 30 may complete device assemblies when no additional cables are required.

The drakkar cap device 30 may be installed when cable laying operations are complete for a particular pathway point. The device 30 may provide final cable organization before connection operations. The device 30 may support service loop formation as specified in installation requirements.

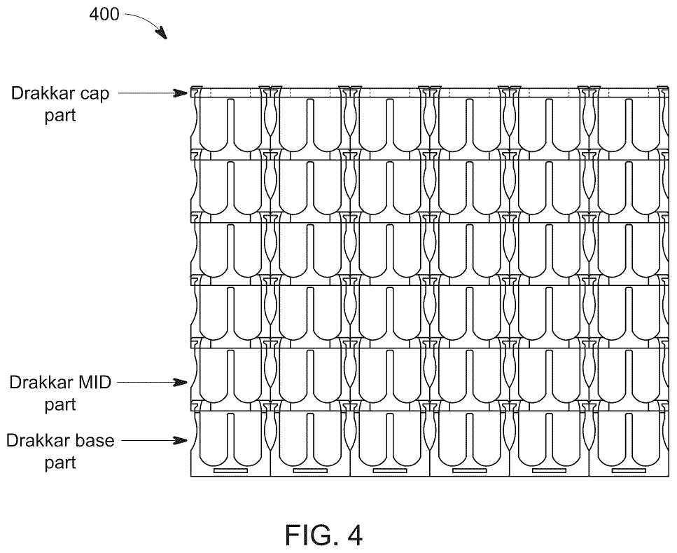

Referring to FIG. 4, an assembly diagram 400 may illustrate the arrangement of drakkar components in operational configurations. The assembly 400 may show drakkar cap parts, drakkar mid parts, and drakkar base parts arranged in grid configurations. The assembly 400 may demonstrate modular stacking capabilities for multiple cable layers.

The assembly 400 may enable technicians to visualize component relationships and installation sequences. The assembly 400 may show how individual devices combine to form complete cable management systems. The assembly 400 may illustrate scalability for various cable quantities and routing requirements.

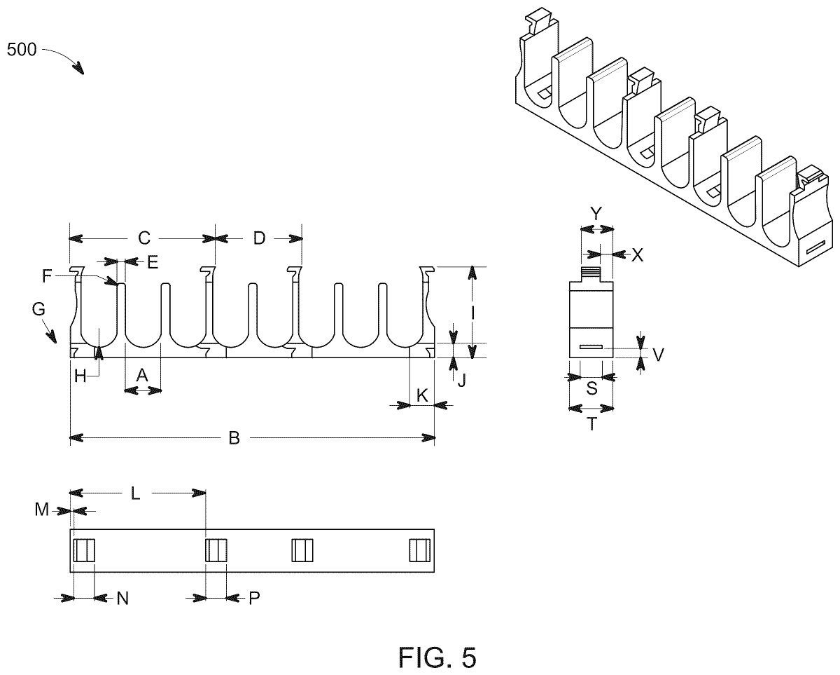

Referring to FIG. 5, a rook device 50 may provide cable dressing and permanent support capabilities. The device 50 may include regularly spaced slots for individual cable positioning. The device 50 may include snap-on connectors for vertical stacking configurations. The device 50 may provide both temporary and permanent cable support functions.

The rook device 50 may be configured as either pull devices for temporary cable dressing or dress devices for permanent cable support. Pull devices may include larger cable channels for dressing operations. Dress devices may include tighter cable fits for permanent installations.

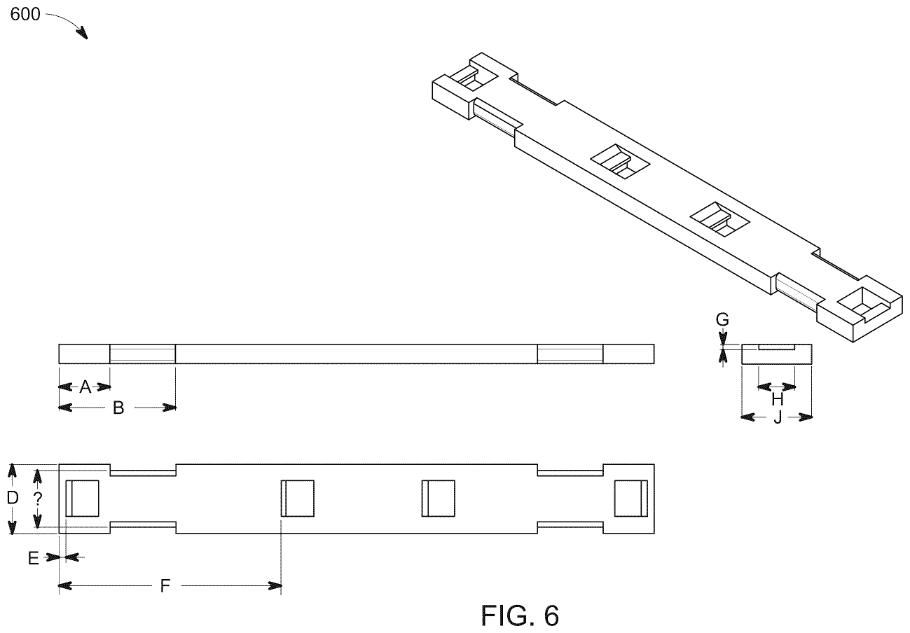

Referring to FIG. 6, a rook cap device 60 may provide termination capability for rook device assemblies. The device 60 may include notches and cutouts for final cable positioning. The device 60 may include snap-on connectors for attachment to rook mid devices. The device 60 may complete both temporary and permanent cable support assemblies.

The rook cap device 60 may be installed to complete temporary comb assemblies for cable dressing operations. The device 60 may also complete permanent support assemblies for long-term cable management. The device 60 may enable individual cable access for maintenance operations.

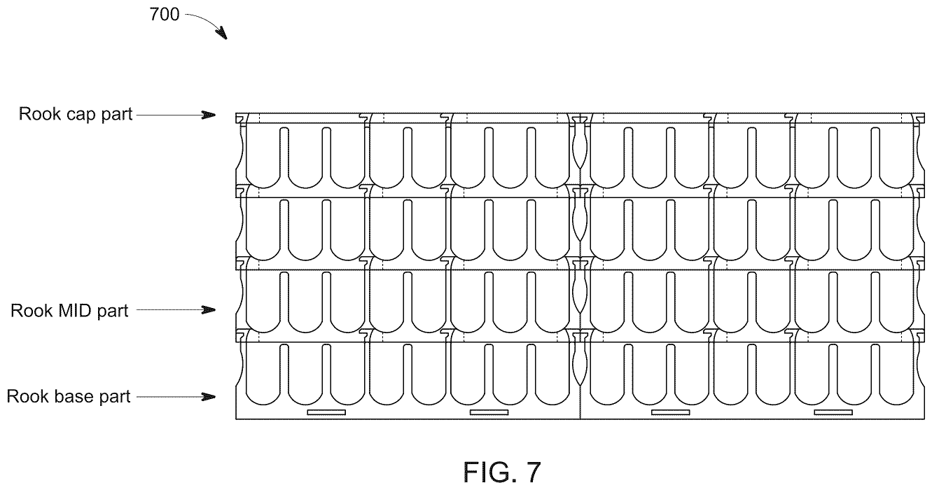

Referring to FIG. 7, a rook system assembly 700 may illustrate the arrangement of rook components in operational configurations. The assembly 700 may show rook cap parts, rook mid parts, and rook base parts arranged in systematic patterns. The assembly 700 may demonstrate both temporary and permanent cable support configurations.

The rook system assembly 700 may enable progressive cable dressing operations along entire cable paths. The assembly 700 may show how temporary combs transition to permanent support systems. The assembly 700 may illustrate maintenance access capabilities for individual cable identification and replacement.

The system may operate through coordinated multi-technician processes. A technician at cable origin may assemble cable bundles with drakkar mid dress devices and secure them with attachment strips. The technician may attach drag lanes to prepared bundles and coordinate with pulling technicians for cable advancement.

Technicians at pathway points may install drakkar base pull devices at predetermined locations. The technicians may receive advancing cable bundles from previous technicians and feed cables into base pull devices while maintaining original patterns. The technicians may install appropriate mid pull or cap pull devices based on requirements.

A technician at cable destination may initiate cable pulling using drag lanes and coordinate with pathway technicians for smooth advancement. The technician may receive cable bundles maintaining original patterns and establish service loops as specified. The technician may enable immediate connection due to preserved patterns.

Cable dressing technicians may install rook pull base devices near cable origins and assemble temporary combs with mid and cap devices. The technicians may move combs progressively along cable paths and install permanent rook dress devices at support points. The technicians may maintain cable patterns throughout dressing processes.

The system may enable simultaneous connections at both cable ends immediately following installation. The system may reduce installation time by approximately fifty percent compared to traditional methods. The system may reduce personnel requirements while improving cable management quality.

The system may enable individual cable identification and replacement without complete bundle disassembly. Maintenance technicians may access individual cables using maintained pattern organization. The technicians may remove and replace cables while preserving bundle integrity.

All system components may be manufactured from various plastic materials. Prototypes may be produced using PLA plastic and 3D printing technology. Production components may be manufactured using injection molding processes. Component dimensions may be variable and adjustable according to customer requirements.

The system may support customization for different cable types and quantities. The system may accommodate various cable routing requirements and pathway configurations. The system may integrate with existing cable support infrastructure and industry standards.

The system may provide significant advantages over traditional cable installation methodologies. The system may eliminate sequential connection requirements through pattern preservation. The system may reduce multiple dressing operations through integrated cable management. The system may enable efficient maintenance through organized cable access.

The system may be applicable across various installation environments including data centers, telecommunications facilities, industrial control systems, and building infrastructure. The system may support structured cabling systems and organized cable routing requirements.

The system may operate within existing regulatory frameworks and industry standards for cable installation and management. The system may support compliance with cable spacing requirements and organization specifications.

It should be understood that the above description is intended to be illustrative, and not restrictive. Many other embodiments will be apparent to those of skill in the art upon reading and understanding the above description. The scope of the embodiments should, therefore, be determined with reference to the appended claims, along with the full scope of equivalents to which such claims are entitled.

The Abstract is provided to comply with 37 C.F.R. § 1.72(b) and will allow the reader to quickly ascertain the nature and gist of the technical disclosure. The Abstract is submitted with the understanding that it will not be used to interpret or limit the scope or meaning of the claims.

What is claimed is:

1. A universal cable installation and management system comprising:
a plurality of drakkar devices including a drakkar mid dress device configured to organize cables into specific patterns and secure the cables with attachment strips, a drakkar base pull device configured to be installed at predetermined pathway points through technical mounting holes, a drakkar mid pull device configured to stack on the drakkar base pull device for accommodating multiple cable layers, and a drakkar cap pull device configured to terminate device stacks;
a plurality of rook devices including a rook pull base device configured to form temporary combs for cable pattern maintenance during dressing operations, a rook pull mid device configured to stack on the rook pull base device for multiple cable layers, a rook pull cap device configured to terminate temporary comb assemblies, a rook dress base device configured to provide permanent support with tighter cable fit than the rook pull base device, a rook dress mid device configured to provide permanent stackable sections, and a rook dress cap device configured to provide permanent termination caps;
wherein all devices include snap-on connectors enabling rapid assembly and disassembly; and
wherein the system is configured to maintain cable organization patterns throughout an entire installation process from initial laying to final dressing and maintenance.

2. The system of claim 1, wherein the drakkar mid dress device is configured to accommodate a predetermined number of cables and secure them with velcro strips.

3. The system of claim 1, wherein the drakkar base pull device is configured to be installed at cable path beginnings, turns, and termination points.

4. The system of claim 1, wherein the drakkar mid pull device is configured to be installed when additional cable bundles are required above current cable installations.

5. The system of claim 1, wherein the drakkar cap pull device is configured to be installed when no additional cables are required above current installations.

6. The system of claim 1, wherein the rook pull devices are configured to form temporary combs that may be moved progressively along cable paths.

7. The system of claim 1, wherein the rook dress devices are configured to provide permanent cable support with tighter cable fits than corresponding rook pull devices.

8. The system of claim 1, wherein all devices are manufactured from plastic materials and may be produced using 3D printing or injection molding processes.

9. The system of claim 1, wherein the system is configured to enable simultaneous connections at both cable ends immediately following installation.

10. The system of claim 1, wherein the system is configured to reduce installation time by approximately fifty percent compared to traditional cable installation methods.

11. A method of cable installation and management comprising:
organizing cables into specific patterns using a drakkar mid dress device;
securing the organized cables with attachment strips;
installing drakkar base pull devices at predetermined pathway points;
pulling the organized cables through the pathway points while maintaining cable patterns using the drakkar base pull devices;
installing drakkar mid pull devices when additional cable layers are required;
installing drakkar cap pull devices to terminate device stacks;
installing rook pull base devices to form temporary combs for cable dressing;
moving the temporary combs progressively along cable paths while maintaining patterns;
installing permanent rook dress devices at support points; and
enabling simultaneous connections at both cable ends due to preserved patterns.

12. The method of claim 11, further comprising positioning technicians at each pathway point to assist cable advancement and pattern maintenance.

13. The method of claim 11, further comprising using drag lanes attached to cable bundles for pulling operations.

14. The method of claim 11, further comprising establishing service loops at cable destinations as specified in installation requirements.

15. The method of claim 11, further comprising performing cable dressing operations from both cable ends toward service loops.

16. The method of claim 11, further comprising enabling individual cable identification and replacement without complete bundle disassembly.

17. The method of claim 11, further comprising reducing personnel requirements while improving cable management quality.

18. An apparatus for cable management comprising:
a base device including technical mounting holes for pathway installation and snap-on connector interfaces for vertical stacking;
a mid device configured to stack on the base device and including cable routing channels for pattern maintenance;
a cap device configured to terminate stacked assemblies and provide final cable routing;
wherein the base device, mid device, and cap device include snap-on connectors enabling rapid assembly and disassembly;
wherein the apparatus is configured to maintain cable organization patterns during installation and dressing operations; and
wherein the apparatus is manufactured from plastic materials and may be customized based on cable requirements.

19. The apparatus of claim 18, wherein the apparatus is configured as either temporary devices for cable dressing operations or permanent devices for long-term cable support.

20. The apparatus of claim 18, wherein the apparatus enables individual cable access for maintenance operations without complete bundle disassembly.
